(19) United States
(12) Patent Application Publication
(10) Pub. No.: US 2021/0026566 A1
(43) Pub. Date: Jan. 28, 2021

(54) STORAGE CONTROL SYSTEM AND METHOD

(71) Applicant: HITACHI, LTD., Tokyo (JP)

(72) Inventors: Keisuke SUZUKI, Tokyo (JP); Hidechika NAKANISHI, Tokyo (JP)

(73) Assignee: HITACHI, LTD., Tokyo (JP)

(21) Appl. No.: 16/813,896

(22) Filed: Mar. 10, 2020

(30) Foreign Application Priority Data
Jul. 26, 2019 (JP) 2019-137830

(51) Int. Cl. G06F 3/06

(52) U.S. Cl. CPC G06F 3/0659; G06F 3/064; G06F 3/0665; G06F 3/067; G06F 3/0611; G06F 3/0614; G06F 3/0683; G06F 3/0629

(57) ABSTRACT

Each node identifies, for each storage device connected to the node, a transfer rate of the storage device from device configuration information including information representing a transfer rate decided between the node and the storage device and which was acquired by an OS of the node. Associated to each chunk is the transfer rate identified by the node to which the storage device, which is a basis of the chunk, is connected. At least one node maintains, for each chunk group, two or more chunks configuring the chunk group as chunks associated with a same transfer rate. The chunks configuring the chunk group are based on the two or more storage devices connected to the two or more nodes. When redundant data is written in the chunks, completion of the write request is replied. The node maintains chunks configuring the chunk group as chunks associated with a same transfer rate.

### CROSS-REFERENCE TO PRIOR APPLICATION

This application relates to and claims the benefit of priority from Japanese Patent Application number 2019-137830, filed on Jul. 26, 2019 the entire disclosure of which is incorporated herein by reference.

### BACKGROUND

The present invention generally relates to the storage control of a node group configured from a plurality of storage nodes.

There are cases where each general purpose computer becomes a storage node by executing SDS (Software Defined Storage) software, and consequently an SDS system is built as an example of a node group (to put it differently, multi node storage system).

The SDS system is an example of a storage system. As a technology for avoiding the deterioration in the write performance of the storage system, for example, known is the technology disclosed in PTL 1. The system disclosed in PTL 1 changes the chunk to be written/accessed to a chunk of a separate storage medium based on the amount of write data of the storage medium, as the allocation source of the chunk to be written/accessed, for the chunk as the unit of striping. According to PTL 1, deterioration in the write performance can be avoided by changing the chunk of the write destination.

[PTL 1] Japanese Unexamined Patent Application Publication No. 2017-199043

### SUMMARY

The configuration of the SDS system is, for example, as follows. Note that, in the ensuing explanation, a “storage node” is hereinafter simply referred to as a “node”.

*A plurality of storage devices are connected to a plurality of nodes.

*Each storage device is connected to one of the nodes, and is not connected to two or more nodes.

*When the SDS system receives a write request, one of the nodes makes redundant the data associated with the write request, writes the redundant data in two or more storage devices connected to two or more different nodes, and notifies the completion of the write request when the writing in the two or more storage devices is completed.

With this kind of SDS system, when there is a difference in the transfer rate of the two or more storage devices as the write destination of redundant data, the notification of the completion of the write request will be dependent on the storage device with the slowest transfer rate. Thus, it is desirable that the two or more storage devices have the same transfer rate.

Nevertheless, because there are cases where the transfer rate between the node and the storage device is determined according to the connection status between the node and the storage device, the foregoing transfer rate may differ from the transfer rate of the storage device indicated in its specification. Thus, it is difficult to maintain a state where the two or more storage devices as the write destination have the same transfer rate.

This kind of problem may also arise in a node group (multi node storage system) other than the SDS system.

At least one node manages a plurality of chunks (plurality of logical storage areas) based on a plurality of storage devices connected to a plurality of nodes. The node to process a write request writes redundant data in two or more storage devices as a basis of two or more chunks configuring a chunk group assigned to a write destination area to which a write destination belongs, and notifies a completion of the write request when writing in the two or more storage devices is completed. The chunk group is configured from two or more chunks based on two or more storage devices connected to two or more nodes. Each node identifies, for each storage device connected to the node, a transfer rate of the storage device from device configuration information which includes information representing a transfer rate decided in establishing a link between the node and the storage device and which was acquired by an OS (Operating System) of the node. Associated to each chunk is the transfer rate identified by the node to which the storage device, which is a basis of the chunk, is connected. At least one node described above maintains, for each chunk group, two or more chunks configuring the chunk group as the two or more chunks associated with a same transfer rate.

It is thereby possible to avoid the deterioration in the write performance of the node group.

Other objects, configurations and effects will become apparent based on the following explanation of the embodiments of this invention.

### BRIEF DESCRIPTION OF THE DRAWINGS

FIG. 1 shows the configuration of the overall system according to an embodiment of the present invention.

FIG. 2 shows an overview of the drive connection processing.

FIG. 3 shows an overview of the pool extension processing.

FIG. 4 shows a part of the configuration of the management table group.

FIG. 5 shows the remaining configuration of the management table group.

FIG. 6 shows an overview of the write processing.

FIG. 7 shows an example of the relationship of the chunks and the chunk groups.

FIG. 8 shows an example of the relationship of the rank groups and the chunks and the chunk groups.

FIG. 9 shows the flow of the processing from the drive connection to the chunk group creation.

FIG. 10 shows an overview of the reconstruction processing of the chunk group.

FIG. 11 shows the flow of the reconstruction processing of the chunk group.

FIG. 12 shows an example of the display of information for the administrator.

### DESCRIPTION OF EMBODIMENTS

In the following explanation, “interface device” may be one or more communication interface devices. The one or more communication interface devices may be one or more similar communication interface devices (for example, one or more NICs (Network Interface Cards)), or two or more different communication interface devices (for example, NIC and HBA (Host Bus Adapter)).

Moreover, in the following explanation, “memory” is one or more memory devices as an example of one or more storage devices, and may typically be a main storage device. The at least one memory device as the memory may be a volatile memory device or a nonvolatile memory device.

Moreover, in the following explanation, “persistent storage device” may be one or more persistent storage devices as an example of one or more storage devices. The persistent storage device may typically be a nonvolatile storage device (for example, auxiliary storage device), and may specifically be, for example, a HDD (Hard Disk Drive), a SSD (Solid State Drive), a NVMe (Non-Volatile Memory Express) drive, or a SCM (Storage Class Memory).

Moreover, in the following explanation, “storage device” may be a memory and at least a memory of the persistent storage device.

Moreover, in the following explanation, “processor” may be one or more processor devices. The at least one processor device may typically be a microprocessor device such as a CPU (Central Processing Unit), but may also be a different type of processor device such as a GPU (Graphics Processing Unit). The at least one processor device may be a single core or a multi core. The at least one processor device may be a processor core. The at least one processor device may be a processor device in a broad sense such as a hardware circuit (for example, FPGA (Field-Programmable Gate Array) or an ASIC (Application Specific Integrated Circuit)) which performs a part or all of the processing.

Moreover, in the following explanation, information in which an output is obtained in response to an input may be explained by using an expression such as “xxx table”, but such information may be data of any structure (for example, structured data or non-structured data), or a learning model such as a neutral network which generates an output in response to an input. Accordingly, “xxx table” may also be referred to as “xxx information”. Moreover, in the following explanation, the configuration of each table is merely an example, and one table may be divided into two or more tables, or all or a part of the two or more tables may be one table.

Moreover, in the following explanation, a function may be explained using an expression such as “kkk unit”, and the function may be realized by one or more computer programs being executed by a processor, or may be realized with one or more hardware circuits (for example, FPGA or ASIC), or may be realized based on the combination thereof. When the function is to be realized by a program being executed by a processor, because predetermined processing is performed by suitably using a storage device and/or an interface device, the function may be at least a part of the processor. The processing explained using the term “function” as the subject may also be the processing to be performed by a processor or a device comprising such processor. A program may be installed from a program source. A program source may be, for example, a program distribution computer or a computer-readable recording medium (for example, non-temporary recording medium). The explanation of each function is an example, and a plurality of functions may be integrated into one function, or one function may be divided into a plurality of functions.

Moreover, in the following explanation, “storage system” includes a node group (for example, distributed system) having a multi node configuration comprising a plurality of storage nodes each having a storage device. Each storage node may comprise one or more RAID (Redundant Array of Independent (or Inexpensive) Disks) groups, but may typically be a general computer. Each of the one or more computers may be built as SDx (Software-Defined anything) as a result of each of such one or more computers executing predetermined software. As SDx, for example, adopted may be SDS (Software Defined Storage) or SDDC (Software-defined Data Center). For example, a storage system as SDS may be built by software having a storage function being executed by each of the one or more general computers. Moreover, one storage node may execute a virtual computer as a host computer and a virtual computer as a controller of the storage system.

Moreover, in the following explanation, when similar components are explained without differentiation, the common number within the reference number is used, and when similar components are explained by being differentiated, the individual reference number may be used. For example, when explanation is provided without specifically differentiating the drives, the drives may be indicated as “drive 10”, and when explanation is provided by differentiating the individual drives, the drives may be indicated as “drive 10A1” and “drive 10A2” or indicated as “drive 10A” and “drive 10B”.

Moreover, in the following explanation, a logical connection between the drive and the node shall be referred to as a “link”.

An embodiment of the present invention is now explained in detail.

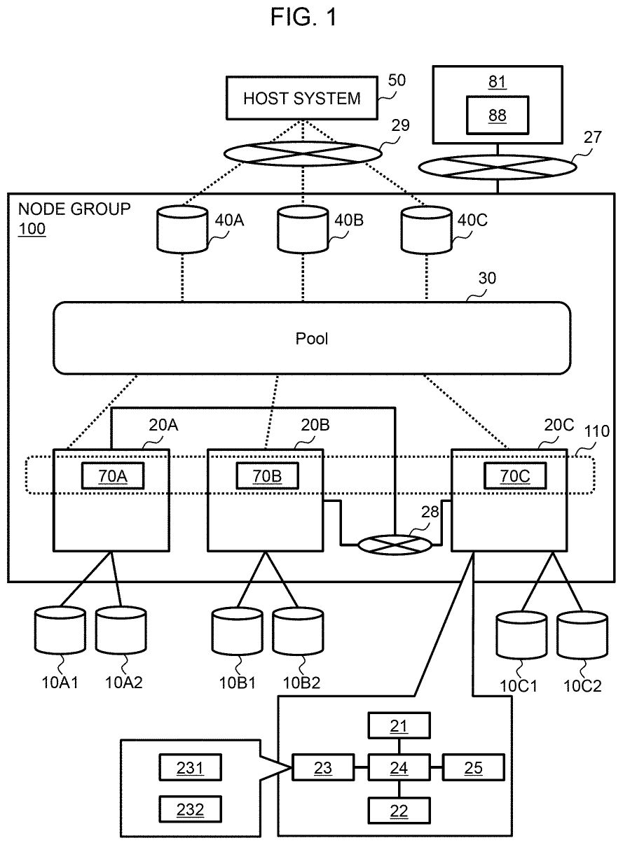

FIG. 1 is a diagram showing the configuration of the overall system according to this embodiment.

There is a node group (multi node storage system) 100 configured from a plurality of nodes 20 (for example, nodes 20A to 20C). One or more drives 10 are connected to each node (storage node) 20. For example, drives 10A1 and 10A2 are connected to the node 20A, drives 10B1 and 10B2 are connected to the node 20B, and drives 10C1 and 10C2 are connected to the node 20C. The drive 10 is an example of a persistent storage device. Each drive 10 is connected to one of the nodes 20, and is not connected to two or more nodes 20.

A plurality of nodes 20 manage a common pool 30. The pool 30 is configured from at least certain chunks among a plurality of chunks (plurality of logical storage areas) based on a plurality of drives 10 connected to a plurality of nodes 20. There may be a plurality of pools 30.

A plurality of nodes 20 provide one or more volumes 40 (for example, volumes 40A to 40C). The volume 40 is recognized by a host system 50 as an example of an issuer of an I/O (Input/Output) request designated by the volume 40. The host system 50 issues a write request to the node group 100 via a network 29. A write destination (for example, volume ID and LBA (Logical Block Address)) is designated in the write request. The host system 50 may be one or more physical or virtual host computers. The host system 50 may also be a virtual computer to be executed in at least one node 20 in substitute for the node group 100. Each volume 40 is associated with the pool 30. The volume 40 is configured, for example, from a plurality of virtual areas (virtual storage areas), and may be a volume pursuant to capacity virtualization technology (typically, Thin Provisioning).

Each node 20 can communicate with the respective nodes 20 other than the relevant node 20 via a network 28. For example, each node 20 may, when a node 20 other than the relevant node 20 has ownership of the volume to which the write designation designated in the received write request belongs, transfer the write request to such other node 20 via the network 28. While the network 28 may also be a network (for example, frontend network) 29 to which each node 20 and the host system 50 are connected, the network 28 may also be a network (for example, backend network) to which the host system 50 is not connected as shown in FIG. 1.

Each node 20 includes a FE-I/F (frontend interface device) 21, a drive I/F (drive interface device) 22, a BE-I/F (backend interface device) 25, a memory 23, and a processor 24 connected to the foregoing components. The FE-I/F 21, the drive I/F 22 and the BE-I/F 25 are examples of an interface device. The FE-I/F 21 is connected to the host system 50 via the network 29. The drive 10 is connected to the drive I/F 22. Each node 20 other than the relevant node 20 is connected to the BE-I/F 22 via the network 28. The memory 23 stores a program group 231 (plurality of programs), and a management table group 232 (plurality of management tables). The program group 231 is executed by the processor 24. The program group 231 includes an OS (Operating System) and a storage control program (for example, SDS software). A storage control unit 70 is realized by the storage control program being executed by the processor 24. At least a part of the management table group 232 may be synchronized between the nodes 20.

A plurality of storage control units 70 (for example, storage control units 70A to 70C) realized respectively by a plurality of nodes 20 configure the storage control system 110. The storage control unit 70 of the node 20 that received a write request processes the received write request. The relevant node 20 may receive a write request without going through any of the nodes 20, or receive such write request (receive the transfer of such write request) from any one of the nodes because the relevant node has ownership of the volume to which the write destination designated in such write request belongs. The storage control unit 70 assigns a chunk from the pool 30 to the write destination area (virtual area of the write destination) to which the write destination designated in the received write request belongs. Details of the write processing including the assignment of a chunk will be explained later.

The node group 100 of FIG. 1 may be configured from one or more clusters. Each cluster may be configured from two or more nodes 20. Each cluster may include an active node, and a standby node which is activated instead of the active node when the active node is stopped.

Moreover, a management system 81 may be connected to at least one node 20 in the node group 100 via the network 27. The management system 81 may be one or more computers. A management unit 88 may be realized in the management system 81 by a predetermined program being executed in the management system 81. The management unit 88 may manage the node group 100. The network 27 may also be the network 29. The management unit 88 may also be equipped in any one of the nodes 20 in substitute for the management system 81.

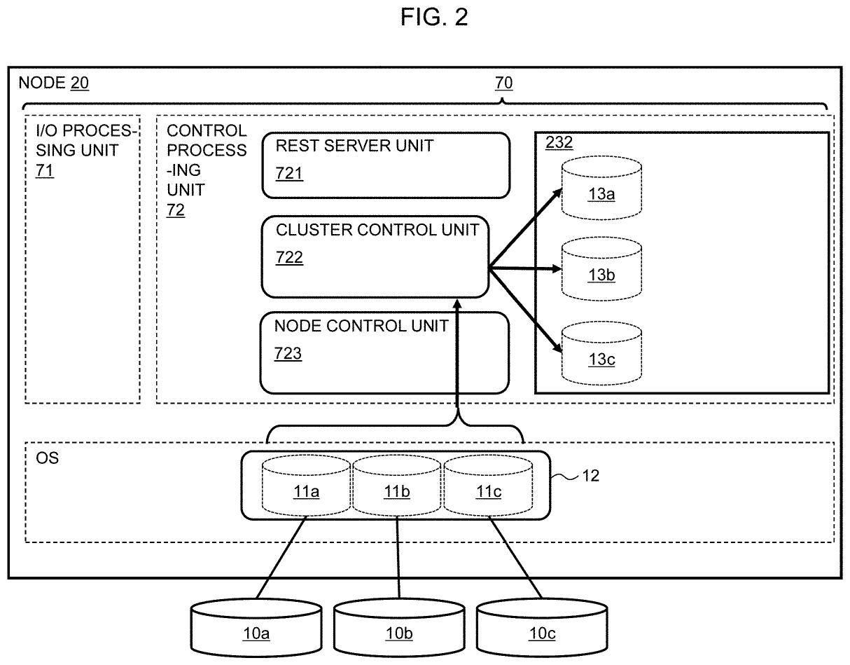

FIG. 2 shows an overview of the drive connection processing.

The storage control unit 70 includes an I/O processing unit 71 and a control processing unit 72.

The I/O processing unit 71 performs I/O (Input/Output) according to an I/O request.

The control processing unit 72 performs pool management between the nodes 20. The control processing unit 72 includes a REST (Representational State Transfer) server unit 721, a cluster control unit 722 and a node control unit 723. The REST server unit 721 receives an instruction of pool extension from the host system 50 or the management system 81. The cluster control unit 722 manages the pool 30 that is shared between the nodes 20. The node control unit 723 detects the drive 10 that has been connected to the node 20.

When a drive 10 is connected to a node 20, the following drive connection processing is performed.

Foremost, communication is performed for establishing a link is between a driver not shown (driver of the connected drive 10) in a node 20 and a drive 10 connected to the node 20 (driver may be included in the OS 95). In this communication, the transfer rate of the drive 10 is decided between the driver and the drive 10. For example, among a plurality of transfer rates that can be selected, the transfer rate according to the status of the drive 10 is selected. The transfer rate decided in the link establishment is a fixed transfer rate such as the maximum transfer rate. For example, after the link is established, communication is performed between the node 20 and the drive 10 at a speed that is equal to or less than the decided transfer rate.

Information representing the decided transfer rate is included in the drive configuration information of the drive 10. The drive configuration information includes, in addition to the transfer rate, information representing the type (for example, standard) and capacity of the drive 10. The OS 95 manages a configuration file 11, which is a file containing the drive configuration information.

The node control unit 723 periodically checks a predetermined area 12 (for example, area storing the configuration file 11 of the connected drive 10 (for example, directory)) among the areas that are managed by the OS 95. When a new configuration file 11 is detected, the node control unit 723 acquires the new configuration file 11 from the OS 95 (predetermined area 12 that is managed by the OS 95), and delivers the acquired configuration file 11 to the cluster control unit 722.

The cluster control unit 722 registers, in the management table group 232, at least a part of the drive configuration information contained in the configuration file 11 from the configuration file 11 delivered from the node control unit 723. A logical space 13 based on the connected drive 10 is thereby shared between the nodes 20.

The drive connection processing described above is performed for each connected drive 10 and, consequently, each of the connected drives 10 and the transfer rate of each drive 10 are shared between the nodes 20. Note that, in FIG. 2, drives 10a, 10b and 10c correspond respectively to configuration files 11a, 11b and 11c, and configuration files 11a, 11b and 11c correspond respectively logical spaces 13a, 13b and 13c.

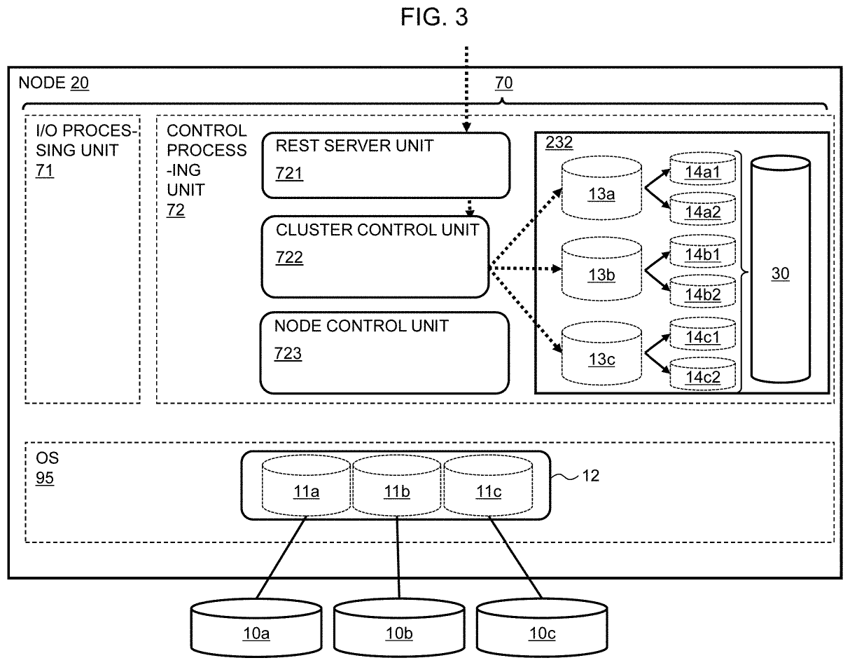

FIG. 3 shows an overview of the pool extension processing.

When the REST server unit 721 receives an instruction of pool extension from the host system 50 or the management system 81, the REST server unit 721 instructs the cluster control unit 722 to perform pool extension. In response to this instruction, the cluster control unit 722 performs the following pool extension processing.

In other words, the cluster control unit 722 refers to the management table group 232, and determines whether there is any undivided logical space 13 (logical space 13 which has not been divided into two or more chunks 14). If there is an undivided logical space 13, the cluster control unit 722 divides such logical space 13 into one or more chunks 14, and adds at least a part of the one or more chunks 14 to the pool 30. The capacity of the chunk 14 is a predetermined capacity. While the capacity of the chunk 14 may also be variable, it is fixed in this embodiment. The capacity of the chunk 14 may also differ depending on the pool 30. A chunk 14 that is not included in the pool 30 may be managed, for example, as an empty chunk 14. According to the example of FIG. 3, chunks 14a1 and 14a2 configuring the logical space 13a, chunks 14b1 and 14b2 configuring the logical space 13b, and chunks 14c1 and 14c2 configuring the logical space 13c are included in the pool 30.

Note that the pool extension processing may also be started automatically without any instruction from the host system 50 or the management system 81. For example, pool extension processing may be performed when the cluster control unit 722 detects that a drive 10 has been newly connected to a node 20 (specifically, when the cluster control unit 722 receives a new configuration file 11 from the node control unit 723). Moreover, for example, pool extension processing may be performed when the load of the node 20 is small, such as when there is no I/O request from the host system 50.

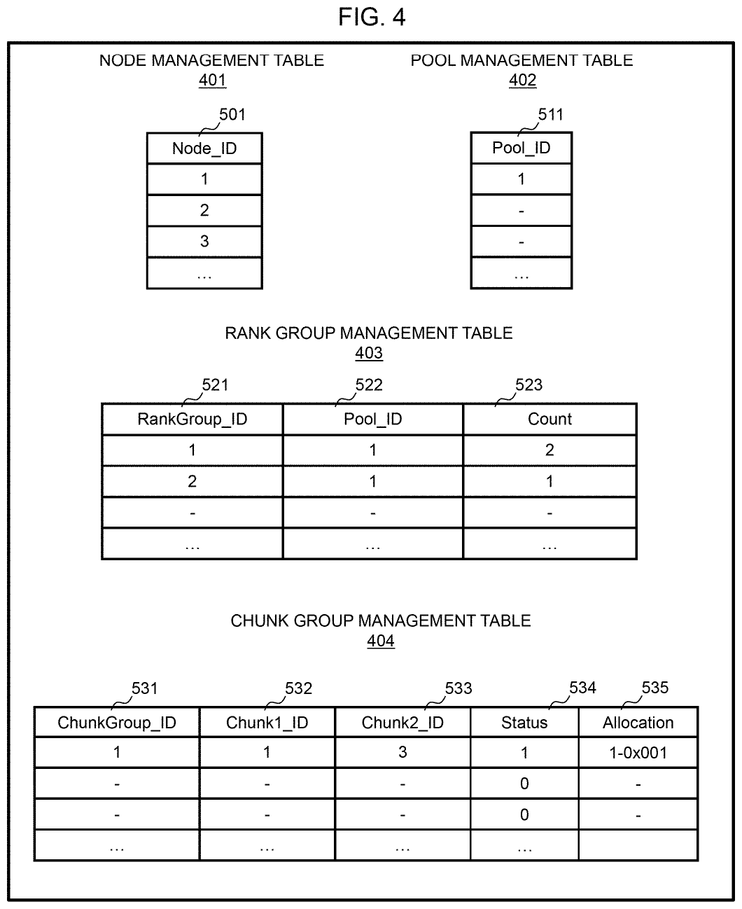

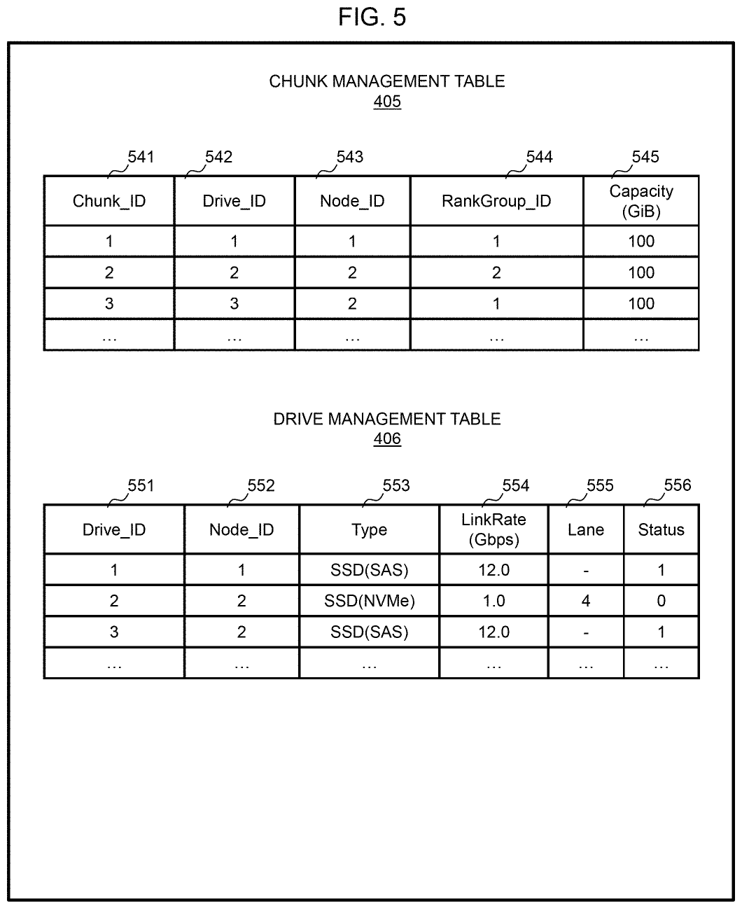

FIG. 4 and FIG. 5 show the configuration of the management table group 232.

The management table group 232 includes a node management table 401, a pool management table 402, a rank group management table 403, a chunk group management table 404, a chunk management table 405 and a drive management table 406.

The node management table 401 is a list of a Node_ID 501. The Node_ID 501 represents the ID of the node 20.

The pool management table 402 is a list of a Pool_ID 511. The Pool_ID 511 represents the ID of the pool 30.

The rank group management table 403 has a record for each rank group. Each record includes information such as a Rank Group_ID 521, a Pool_ID 522, and a Count 523. One rank group is now taken as an example (this rank group is hereinafter referred to as the “target rank group” at this stage). The Rank Group_ID 521 represents the ID of the target rank group. The Pool_ID 522 represents the ID of the pool 30 to which the target rank group belongs. The Count 523 represents the number of chunk groups (or chunks 14) that belong to the target rank group. Note that the term “rank group” refers to the group to which the chunks 14, with which the same transfer rate has been associated, belong. In other words, if the transfer rate associated with a chunk 14 is different, then the rank group to which such chunk belongs will also be different.

The chunk group management table 404 has a record for each chunk group. Each record includes information such as a Chunk Group_ID 531, a Chunk 1_ID 532, a Chunk 533, a Status 534 and an Allocation 535 (this chunk group is hereinafter referred to as the “target chunk group” at this stage). The Chunk Group_ID 531 represents the ID of the target chunk group. The Chunk 1_ID 532 represents the ID of a first chunk 14 of the two chunks 14 to which the target chunk group belongs. The Chunk 2_ID 532 represents the ID of a second chunk 14 of the two chunks 14 to which the target chunk group belongs. The Status 534 represents the status of the target chunk group (for example, whether the target chunk group (or the first chunk 14 of the target chunk group) has been allocated to any one of the volumes 40). The Allocation 535 represents, when the target chunk group has been allocated to any one of the volumes 40, the allocation destination (for example, volume ID and LBA) of the target chunk group. Note that the term “chunk group” refers to the group of the two chunks 14 based on the two drives 10 connected to two different nodes 20. In this embodiment, while two chunks 14 are configuring the chunk group, three or more chunks 14 (for example, three or more chunks 14 configuring the stripe of a RAID group configured based on three or more drives 10) based on three or more drives 10 connected to three or more different nodes 20 may also configure one chunk group.

The chunk management table 405 has a record for each chunk. Each record includes information such as a Chunk_ID 541, a Drive_ID 542, a Node_ID 543, a Rank Group_ID 544 and a Capacity 545. One chunk 14 is now taken as an example (this chunk 14 is hereinafter referred to as the “target chunk 14” at this stage). The Chunk_ID 541 represents the ID of the target chunk 14. The Drive_ID 542 represents the ID of the drive 10 that is the basis of the target chunk 14. The Node_ID 543 represents the ID of the node 20 to which the drive 10, which is the basis of the target chunk 14, is connected. The Rank Group_ID 544 represents the ID of the rank group to which the target chunk 14 belongs. The Capacity 545 represents the capacity of the target chunk 14.

The drive management table 406 has a record for each drive 10. Each record includes information such as a Drive_ID 551, a Node_ID 552, a Type 553, a Link Rate 554, a Lane 555 and a Status 556. One drive 10 is now taken as an example (this drive 10 is hereinafter referred to as the “target drive 10” at this stage). The Drive_ID 551 represents the ID of the target drive 10. The Node_ID 552 represents the ID of the node 20 to which the target drive 10 is connected. The Type 553 represents the type (standard) of the target drive 10. The Link Rate 554 represents the link rate (speed) per lane of the target drive 10. The Lane 555 represents the number of lanes between the target drive 10 and the node 20. The Status 556 represents the status of the target drive 10 (for example, whether the logical space 13 based on the target drive 10 has been divided into two or more chunks 14).

The link rate of the target drive 10 is decided in the communication for establishing a link between the target drive 10 and the driver (OS 95). The transfer rate of the target drive 10 follows the Link Rate 554 and the Lane 555. The Lane 555 is effective, for example, when the target drive 10 is an NVMe drive.

An example of the tables included in the management table group 232 has been explained above. While not shown, the management table group 232 may also include a volume management table. The volume management table may include information, for each volume 40, representing whether the LBA range and the chunk 14 have been allocated to each virtual area.

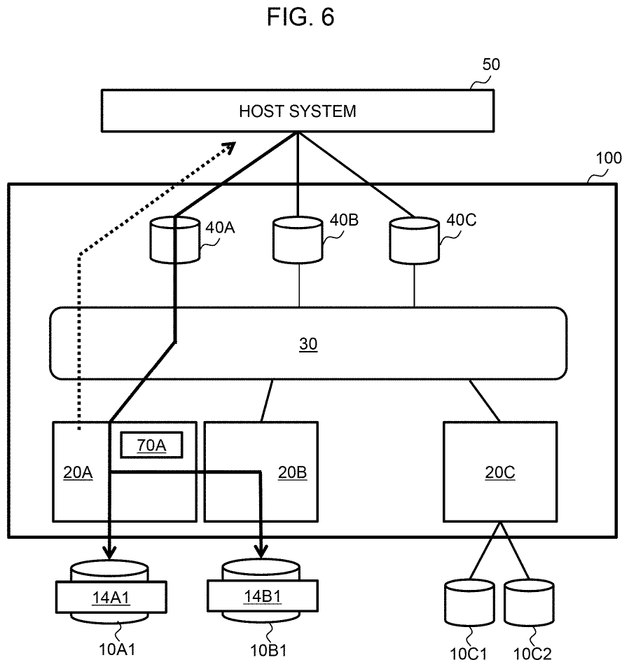

FIG. 6 shows an overview of the write processing.

One or more chunk groups are allocated to the volume 40, for example, when such volume 40 is created. For example, when the capacity of the chunk 14 is 100 GB, the capacity of the chunk group configured from two chunks 14 will be 200 GB. Nevertheless, because data is made redundant and written in the chunk group, the capacity of data that can be written in the chunk group is 100 GB. Thus, when the capacity of the volume 40 is 200 GB, two unallocated chunk groups (for example, chunk grounds in which the value of the Allocation 535 is “-”) will be allocated.

Let it be assumed that the node 20A received, from the host system 50, a write request designating an LBA in the volume 40A. Moreover, let it be assumed that the node 20A has ownership of the volume 40A.

The storage control unit 70A of the node 20A makes redundant the data associated with the write request. The storage control unit 70A refers to the chunk group management table 404 and identifies the chunk group which is allocated to the write destination area to which the LBA designated in the write request belongs.

Let it be assumed that the identified chunk group is configured from a chunk 14A1 based on a drive 10A1 and a chunk 14B1 based on a drive 10B1. The storage control unit 70A writes the redundant data in the chunks 14A1 and 14B1 configuring the identified chunk group. In other words, data is written respectively in the drives 10A1 and 10B1.

When the writing of data in the chunks 14A1 and 14B1 (drives 10A1 and 10B1) is completed, the storage control unit 70A notifies the completion of the write request to the host system 50, which is the source of the write request.

Note that the write processing may also be performed by the I/O processing unit 71 in the storage control unit 70.

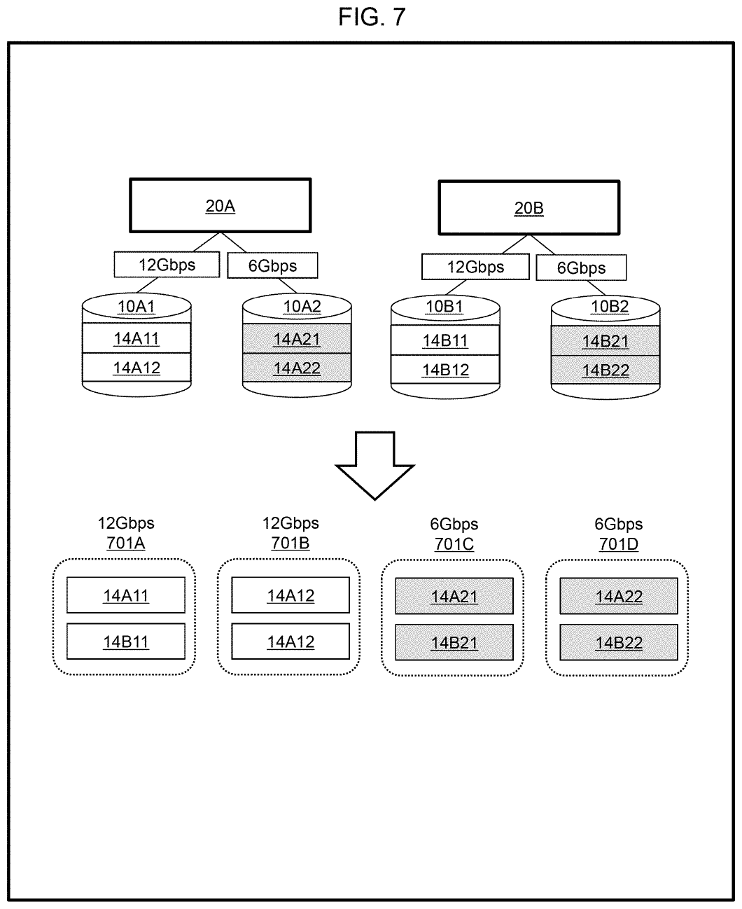

FIG. 7 shows an example of the relationship of the chunks and the chunk groups.

At least certain chunks 14 among a plurality of chunks 14 configure a plurality of chunk groups 701. Each chunk group 701 is configured from two chunks 14 based on two drives 10 connected to two nodes 20. This is because, if the chunk group 701 is configured from two chunks 14 connected to the same node 20, I/O to and from any of the chunks 14 will not be possible when the relevant node 20 stops due to a failure or the like (for example, when the relevant node 20 changes from an active state to a standby state).

Moreover, the transfer rate of two or more drives 10 connected to one node 20 is not necessarily the same. Even when all of the drives 10 connected to a node 20 are drives 10 of the same vendor, same capacity and same type; that is, even when the drives 10 all have the same transfer rate (for example, maximum transfer rate) according to their specification, there are cases where the transfer rate is different between the node 20 and the drive 10. This is because the transfer rate that is decided in the communication for establishing a link between the node 20 and the drive 10 may differ depending on the communication status between the node 20 and the drive 10. For example, as illustrated in FIG. 7, there may be cases where a drive 10A1 having a transfer rate of “12 Gbps” and a drive 10A2 having a transfer rate of “6 Gbps” are connected to a node 20A. Similarly, there may be cases where a drive 10B1 having a transfer rate of “12 Gbps” and a drive 10B2 having a transfer rate of “6 Gbps” are connected to a node 20B. More specifically, there are the following examples.

*When the drive 10 is a SAS (Serial Attached SCSI) drive, while a transfer rate among a plurality of transfer rates is selected as the transfer rate between the node 20 and the drive 10 in the communication for establishing a link, the selected transfer rate will differ depending on at least one of either the type (for example, whether the drive 10 is an SSD or an HDD) or status (for example, load status or communication status) of the drive 10.

*When the drive 10 is an NVMe drive, the transfer rate between the node 20 and the drive 10 is decided based on the number of lanes between the node 20 and the drive 10 and the link rate per lane. The number of lanes differs depending on the drive type. Moreover, the link rate per lane differs depending on at least one of either the type or status of the drive 10.

In the foregoing environment, when the two chunks 14 as the write destination of the redundant data are chunks based on two drives 10 having a different transfer rate, the write performance will be dependent on the drive 10 with the slower transfer rate.

Thus, in this embodiment, as described above, the storage control unit 70 in each node 20 identifies, for each drive 10 connected to the relevant node 20, the transfer rate of such drive 10 from the device configuration information which includes information representing the transfer rate decided between the node 20 and the drive 10 and which was acquired by the OS 95, and associates the identified transfer rate with the chunk 14 based on such drive 10. Subsequently, the storage control unit 70 in at least one node 20 (for example, master node 20) configures one chunk group 701 with the two chunks 14 with which the same transfer rate has been associated. One chunk 14 is never included in different chunk groups 701. According to the example of FIG. 7, this will consequently be as follows.

*A chunk group 701A is configured from chunks 14A11 and 14B11 based on drives 10A1 and 10B1 having a transfer rate of “12 Gbps”. Similarly, a chunk group 701B is configured from chunks 14A12 and 14B12 based on drives 10A1 and 10B1 having a transfer rate of “12 Gbps”.

*A chunk group 701C is configured from chunks 14A21 and 14B21 based on drives 10A2 and 10B2 having a transfer rate of “6 Gbps”. Similarly, a chunk group 701D is configured from chunks 14A22 and 14B22 based on drives 10A2 and 10B2 having a transfer rate of “6 Gbps”.

It is thereby possible to guarantee that the transfer rate of the two chunks 14 as the write destination of redundant data will be the same, and consequently avoid the deterioration in the write performance (delay in responding to the write request) caused by a difference in the transfer rates. Note that, with the two chunks 14 configuring the chunk group 701, the drive type of the two drives 10 as the basis may also be the same in addition to the transfer rate being the same. Moreover, the number of chunks does not have to be the same for all chunk groups 701. The number of chunks 14 configuring the chunk group 701 may differ depending on the level of redundancy. For example, a chunk group 710 to which RAID 5 has been applied may be configured from three or more chunks based on three or more NVMe drives.

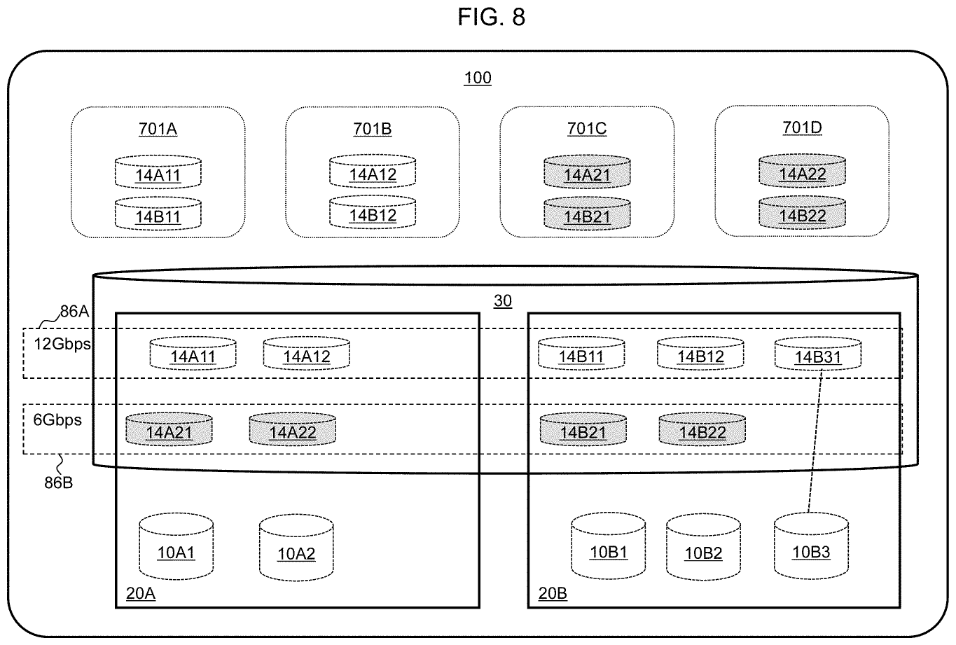

FIG. 8 shows an example of the relationship of the rank groups 86 and the chunks 14 and the chunk groups 701.

Let it be assumed that the transfer rate that was decided regarding the drive 10 as the basis of the chunk 14 configuring the pool 30 is either “12 Gbps” or “6 Gbps”. In the foregoing case, as the rank groups 86, there are a rank group 86A to which belongs the chunk 14 based on the drive 10 having a transfer rate of “12 Gbps”, and a rank group 86B to which belongs the chunk 14 based on the drive 10 having a transfer rate of “6 Gbps”. According to the configuration illustrated in FIG. 7, this will be as per the configuration illustrated in FIG. 8. In other words, chunks 14A11 and 14A12 based on a drive 10A1 and chunks 14B11 and 14B12 based on a drive 10B1 belong to the rank group 86A. Chunks 14A21 and 14A22 based on a drive 10A2 and chunks 14B21 and 14B22 based on a drive 10B2 belong to the rank group 86B. Furthermore, when a drive 10B3 is connected to a node 20B and the transfer rate between the node 20B and the drive 10B3 is decided to be “12 Gbps”, a chunk 14B31 based on the drive 10B3 is added to the rank group 86A. Note that the added chunk 14B31 is a backup chunk that does not configure any of the chunk groups 701. A backup chunk may not be allocated to any of the volumes 40. The chunk 14B31 is a chunk that may be allocated to the volume 40 when it becomes a constituent element of any one of the chunk groups 701.

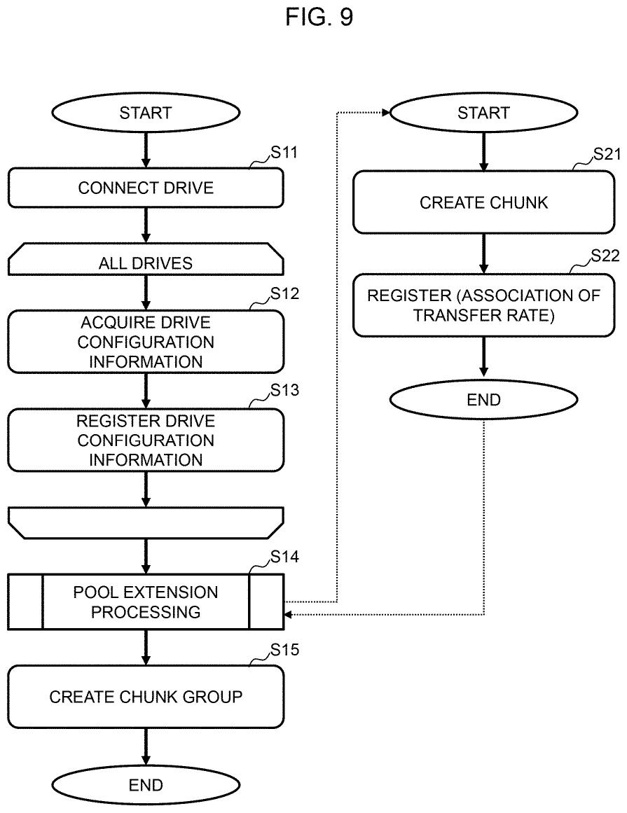

FIG. 9 shows the flow of the processing from the drive connection to the chunk group creation.

One or more drives 10 are connected to any one of the nodes 20 (S11). The OS 95 adds, to a predetermined area 12, one or more configuration files 11 corresponding respectively to the one or more connected drives 10 (refer to FIG. 2). The node control unit 723 acquires, from the predetermined area 12, the one or more added configuration files 11, and delivers the one or more acquired configuration files 11 to the cluster control unit 722.

The cluster control unit 722 acquires drive configuration information from the configuration file 11 regarding each of the one or more connected drives 10 (one or more configuration files 11 received from the node control unit 723) (S12), and registers the acquired drive configuration information in the management table group 232. A record is thereby added to the drive management table 406 for each drive 10. Among the records, information 553 to 555 is information included in the drive configuration information, and information 551, 552 and 556 is information decided by the cluster control unit 722.

Subsequently, the cluster control unit 722 performs pool extension processing (S14). Specifically, the cluster control unit 722 divides each of the one or more logical spaces 13 (refer to FIG. 2 and FIG. 3) based on the one or more connected drives 10 into a plurality of chunks 14 (S21), and registers information related to each chunk 14 in the management table group 232 (S22). A record is thereby added to the chunk management table 405 for each chunk 14. Consequently, associated with each chunk 14 is the transfer rate of the drive 10 as the basis of the relevant chunk 14. Specifically, the Drive_ID 542 is registered for each chunk 14, and information 554 and 555 representing the transfer rate is associated with the Drive_ID 551 which coincides with the Drive_ID 542.

Finally, the cluster control unit 722 creates a plurality of chunk groups 701 (S15). Each chunk group 701 is configured from two chunks 14 having the same transfer rate. Note that, for each chunk 14 that is now a constituent element of the chunk group 701, the Status 534 is updated to a value representing that the relevant chunk 14 is now a constituent element of the chunk group 701. A chunk 14 that is not a constituent element of the chunk group 701 may be managed as a backup chunk 14.

Note that the expression “same transfer rate” is not limited to the exact match of the transfer rates, and may include cases where the transfer rates differ within an acceptable range (range in which the transfer rates can be deemed to be the same).

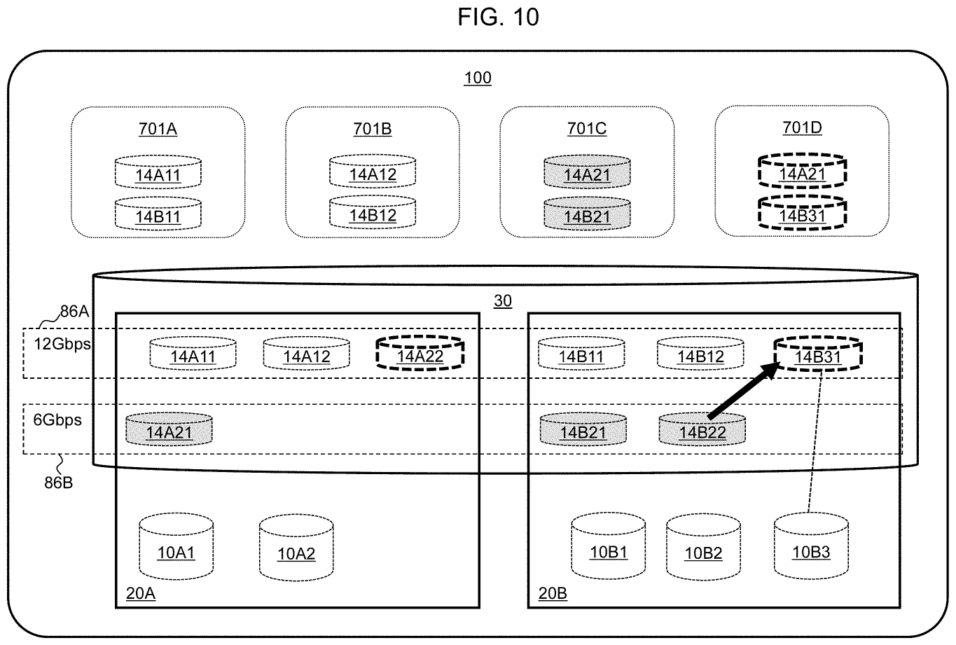

FIG. 10 shows an overview of the reconstruction processing of the chunk group 701.

There are cases where the link of the drive 10 is once disconnected and then reestablished. The reestablishment of the link may be performed in response to an explicit instruction from the host system 50 or the management system 81, or automatically performed when the data transfer to the drive 10 is unsuccessful. The transfer rate of the drive 10 between the drive 10 and the node 20 is also decided in the reestablishment of the link. The decided transfer rate may differ from the transfer rate that was decided in the immediately preceding establishment of the link of the relevant drive 10; that is, the transfer rate of the drive 10 may change midway during the process.

Consequently, there are cases where the transfer rates associated with two chunks 14 may differ in at least one chunk group 701. For example, in the configuration illustrated in FIG. 8, when the transfer rate of the drive 10A2 changes from “6 Gbps” to “12 Gbps”, the transfer rate associated with each of the chunks 14A21 and 14A22 based on the drive 10A2 will also change from “6 Gbps” to “12 Gbps”.

The example shown in FIG. 10 is an example which focuses on the chunk 14A22. Because the transfer rate associated with the chunk 14A22 is “12 Gbps”, as shown in FIG. 10, the rank group 86 to which the chunk 14A22 belongs has been changed from the rank group 86B to the rank group 86A.

If nothing is done, the transfer rate of the chunk 14B22 in the chunk group 701D will differ from the transfer rate of the chunk 14A22. Thus, the write performance in the chunk group 701D will deteriorate.

Thus, in this embodiment, the storage control unit 70B of the node 20B finds an empty chunk 14B31 having a transfer rate of “12 Gbps”, and transfers, to the chunk 14B31, the data in the chunk 14B22 having a transfer rate of “6 Gbps”. Subsequently, the storage control unit 70B changes the constituent element of the chunk group 701D from the chunk 14B22 of the transfer source to the chunk 14B31 of the transfer destination. The same transfer rate of the two chunks 14A21 and 14B31 configuring the chunk group 701D is thereby maintained. It is thereby possible to avoid the deterioration in the write performance in the chunk group 701D.

Note that, while the explanation focuses on the chunk 14A22 according to the example illustrated in FIG. 10, the same processing is also performed for the chunk 14A21.

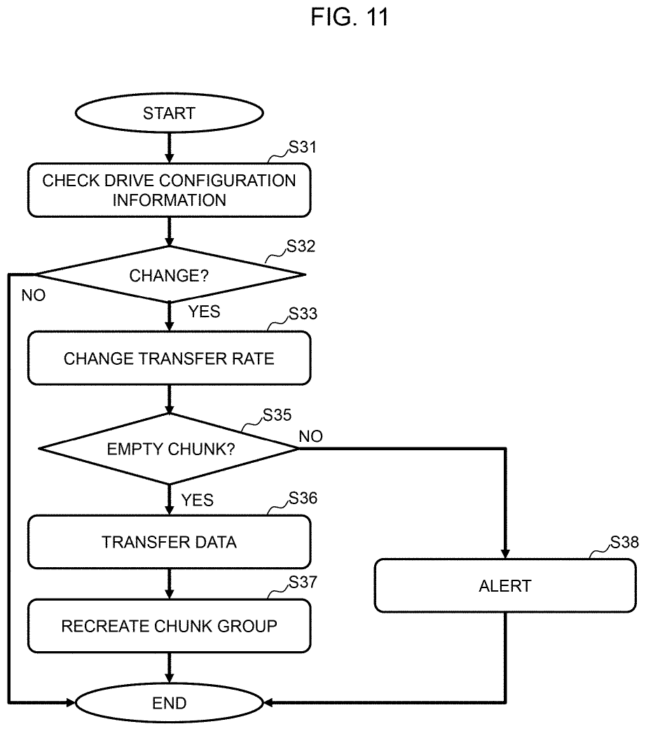

FIG. 11 shows the flow of the reconstruction processing of the chunk group 701. The reconstruction processing shown in FIG. 11 may be performed by one node 20 (for example, master node) in the node group 100, in this embodiment, it can also be executed by each node 20. The node 20A is now taken as an example. The reconstruction processing is performed periodically.

The node control unit 723 of the node 20A checks, for each configuration in a predetermined area (area where the configuration file of the drive 10A2 is being stored) of the node 20A, whether the transfer rate represented with the drive configuration information in the relevant configuration file differs from the transfer rate in the drive management table 406 (S31). If no change in the transfer rate is detected in any of the drives 10 (S32: No), the reconstruction processing is ended.

In the following explanation, as illustrated in FIG. 10, let it be assumed that the link between the node 20A and the drive 10A2 is reestablished, and consequently the latest transfer rate (transfer rate represented with the drive configuration information in the configuration file) of the drive 10A2 differs from the transfer rate registered in the drive management table 406 regarding the drive 10A2.

When a change in the transfer rate of the drive 10A2 is detected (S32: YES), the cluster control unit 722 of the node 20A changes the transfer rate (information 554 and 555) of the drive 10A2 (S33). In the following explanation, the chunk 14A22 is taken as an example in the same manner as FIG. 10.

The cluster control unit 722 of the node 20A determines whether there is any empty chunk associated with the same transfer rate as the new transfer rate from the management table group 232 of the node 20A (S35). The term “empty chunk” as used herein refers to a chunk in which the Status 534, which corresponds to the Drive_ID 542 that coincides with the Drive_ID 551 associated with the same transfer rate as the new transfer rate, has a value that means “empty”. An empty chunk may be searched, for example, in the following manner.

*The cluster control unit 722 of the node 20A identifies the chunk 14B22 in the chunk group 701D, which includes the chunk 14A22, from the chunk group management table 404.

*The cluster control unit 722 of the node 20A identifies the node 20B, which is managing the chunk 14B22, from the chunk management table 405.

*The cluster control unit 722 of the node 20A searches for an empty chunk 14B associated with the same transfer rate as the new transfer rate among the chunks 14B, which are being managed by the node 20B, based on the chunk management table 405 and the drive management table 406.

*If such an empty chunk 14B is not found, the cluster control unit 722 of the node 20A searches for an empty chunk 14 associated with the same transfer rate as the new transfer rate among the chunks being managed by a node other than the nodes 20A and 20B based on the chunk management table 405 and the drive management table 406.

Let it be assumed that an empty chunk 14B31 is found. In the foregoing case (S35: YES), data transfer is performed (S36). For example, the cluster control unit 722 of the node 20A instructs the cluster control unit 722 of the node 20B managing the empty chunk 14B31 to transfer data from the chunk 14B22 to the empty chunk 14B31. In response to the foregoing instruction, the cluster control unit 722 of the node 20B transfers the data from the chunk 14B22 to the empty chunk 14B31, and notifies the completion of transfer to the cluster control unit 722 of the node 20A.

After S36, the cluster control unit 722 of the node 20A reconfigures the chunk group 701D including the chunk 14A22 (S37). Specifically, the cluster control unit 722 of the node 20A includes the chunk 14B31 of the transfer destination in the chunk group 701D in substitute for the chunk 14B22 of the transfer source. More specifically, the cluster control unit 722 of the node 20A changes the Chunk 1_ID 532 or the Chunk 2_ID 533 of the chunk group 701D from the ID of the chunk 14B22 of the transfer source to the ID of the chunk 14B31 of the transfer destination.

Let it be assumed that an empty chunk associated with the same transfer rate as the new transfer rate was not found. In the foregoing case (S35: NO), the transfer rate of the two chunks configuring the chunk group 701D will continue to be different. Thus, the cluster control unit 722 of the node 20A (or the management unit 88 in the management system 81) outputs an alert implying that there is a possibility of deterioration in the drive performance (S38).

According to the reconstruction processing described above, as a result of the node control unit 723 periodically checking each configuration file acquired by the OS 95, even if the transfer rate between the driver and the drive 10 changes midway in the process, such change of the transfer rate can be detected. Subsequently, an empty chunk 14B31 having the same transfer rate as the new transfer rate of the chunk 14A22 is searched for the chunk 14B22 (chunk 14B22 based on the drive 10B2 with no change in the transfer rate) in the chunk group 701D which includes the chunk 14A22 based on the drive 10A2 in which the transfer rate has changed. Data from the chunk 14B22 is transferred to the foregoing empty chunk 14B31. Subsequently, the chunk 14B31 of the transfer destination becomes a constituent element of the chunk group 701D in substitute for the chunk 14B22. Even when the transfer rate of the drive 10A2 changes midway in the process, the transfer rate of the two chunks configuring the chunk group 701D can be maintained to be the same in the manner described above.

As a method of maintaining the transfer rate of the who chunks configuring the chunk group 701D to be the same, considered may be a method of performing the data transfer between the node 20A and the drive 10A2 according to the old transfer rate even when the transfer rate of the drive 10A2 becomes faster, but the speed of the data transfer between the node 20A and the drive 10A2 cannot be controlled from the storage control unit 70 running on the OS 95. In other words, the data transfer between the node 20A and the drive 10A2 will be performed according to the new transfer rate. Thus, by transferring the data in the chunk 14B22 with no change in the transfer rate to a chunk having the same transfer rate as the new transfer rate and switching the constituent element of the chunk group from the chunk of the transfer source to the chunk of the transfer destination, the transfer rate of the two chunks configuring the chunk group 701D can be maintained to be the same.

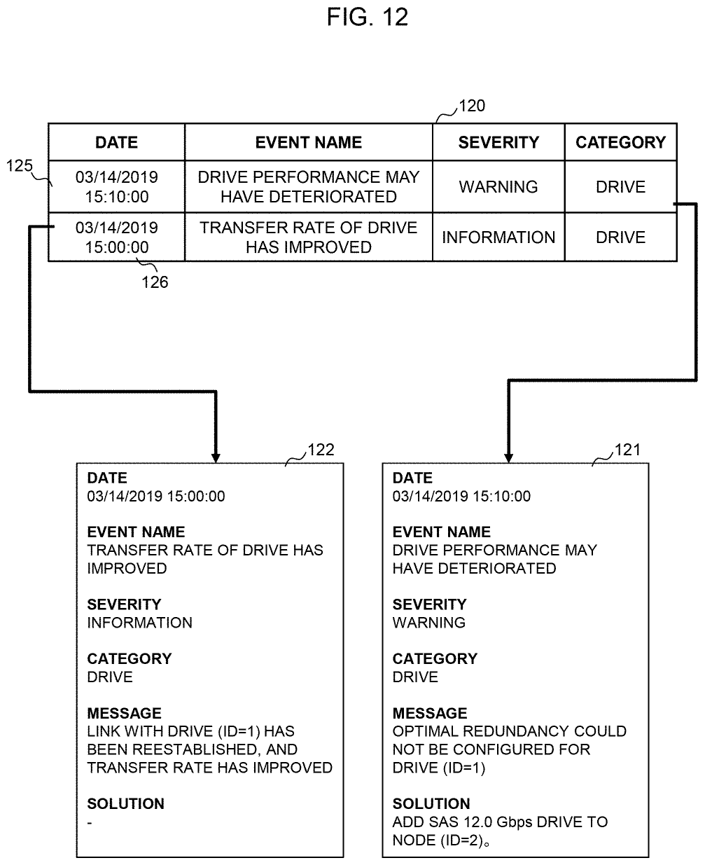

FIG. 12 shows an example of the display of information for the administrator.

Information 120 as an example of information for an administrator includes alert information 125 and notice information 126. The information 120 is displayed on a display device. The display device may be equipped in a management system 81, which is an example of a computer connected to the node group 100, or be equipped in a computer connected to the management system 81. The information 120 is generated by displayed by the storage control unit 70 in the target node 20 (example of at least one node) or by the management unit 88 in the management system 81 (example of a system which communicates with the target node 20). In the explanation of FIG. 12, the term “target node” may be the master node in the node group 100, or a node which detected the status represented by the information 120 among the nodes in the node group 100.

The alert information 125 is information that is generated by the storage control unit 70 in the target node 20 or by the management unit 88 in the management system 81 when an empty chunk associated with the same transfer rate as the new transfer rate was not found, and is information representing that there is a possibility of deterioration in the performance. The alert information 125 includes, for example, information indicating the date and time that the possibility of deterioration in the performance deterioration occurred, and the name of the event representing that the possibility of the deterioration in the performance deterioration has occurred. The administrator (example of a user) can know the possibility of deterioration in the performance by viewing the alert information 125. Note that the storage control unit 70 or the management unit 88 may also generate and display alert detailed information 121, which indicates the details of the alert information 125, in response to a predetermined operation by the administrator. The alert detailed information 121 includes the presentation of adding a drive 10 having the same transfer rate as the new transfer rate. The administrator is thereby able to know what measure needs to be taken to avoid the possibility of deterioration in the performance.

The notice information 126 is information representing the status corresponding to a predetermined condition among the detected statuses. The administrator can know that a status corresponding to a predetermined condition has occurred by viewing the notice information 126. The storage control unit 70 or the management unit 88 may also generate and display the notice detailed information 122, which indicates the details of the notice information 126, in response to a predetermined operation by the administrator. As an example of a “status corresponding to a predetermined condition”, there is improvement in the transfer rate. As a case example in which the transfer rate is improved, for example, there is the following.

*A drive 10 having the same transfer rate as the new transfer rate has been added. Consequently, even in the case of “S35: NO” of FIG. 11, an empty chunk having the same transfer rate as the new transfer rate will increase and, therefore, an empty chunk of the transfer destination of the chunk 14B11 will be found.

*The transfer rate of the drive 10A2 is changed to a faster transfer rate (that is, transfer rate improves), and S36 and S37 described above are performed.

While an embodiment of the present invention was explained above, it goes without saying that the present invention is not limited to the foregoing embodiment, and may be variously modified within a range that does not deviate from the subject matter thereof.

For example, there are cases where the transfer rate of the drive 10A1 changes to a slower transfer rate (that is, transfer rate worsens). In the foregoing case, for example, from the standpoint of FIG. 10, data in the chunk 14B11 of the chunk group 701A, which includes the chunk 14A11 based on the drive 10A1, is transferred to an empty chunk associated with the same slower transfer rate, and the chunk 14B11 in the chunk group 701A is changed to be such empty chunk.

Moreover, instead of one or more chunk groups being allocated to the entire area of the volume 40 when such volume 40 is created, they may also be dynamically allocated to the chunk group in response to the reception of a write request. For example, when the node 20 receives a write request designating a write destination in the volume 40 and a chunk group has not been allocated to such write destination, the node 20 may allocate an unallocated chunk group to the write destination area to which such write destination belongs.

What is claimed is:

1. A storage control system, comprising:
a plurality of storage control units each equipped in a plurality of storage nodes configuring a node group,
wherein:
a plurality of storage devices are coupled to the plurality of storage nodes, each of the storage devices is coupled to one of the storage nodes and is not coupled to two or more storage nodes,
the storage control unit in at least one storage node among the plurality of storage nodes manages a plurality of chunks, which are a plurality of logical storage areas, based on the plurality of storage devices,
when the node group receives a write request designating a write destination in a volume, one of the storage control units makes redundant data associated with the write request, writes the redundant data in two or more storage devices which are a basis of two or more chunks configuring a chunk group assigned to a write destination area to which the write destination belongs, and notifies a completion of the write request when writing in the two or more storage devices is completed,
the chunk group is configured from two or more chunks based on two or more storage devices coupled to two or more storage nodes,
in each of the plurality of storage nodes, the storage control unit identifies, for each storage device coupled to the storage node, a transfer rate of the storage device from device configuration information which includes information representing a transfer rate decided in establishing a link between the storage node and the storage device and which was acquired by an OS (Operating System) of the storage node,
associated to each chunk is the transfer rate identified by the storage control unit in the storage node to which the storage device, which is a basis of the chunk, is connected, and
the storage control unit in the at least one storage node maintains, for each of the chunk groups, two or more chunks configuring the chunk group as the two or more chunks associated with a same transfer rate.

2. The storage control system according to claim 1, wherein:
in each of the plurality of storage nodes, the storage control unit in the storage node periodically identifies, for each storage device coupled to the storage node, the transfer rate of the storage information from the device configuration information of the storage device,
when the storage control unit in the at least one storage node detects a storage device in which the transfer rate has changed, the storage control unit, for each chunk based on the storage device:
searches for a target chunk, which is a chunk associated with a transfer rate that is the same as a latest transfer rate of the storage device;
when the target chunk is discovered, transfers data in the chunk, which is an original chunk, to the target chunk; and
includes the target chunk, in substitute for the original chunk, in the chunk group containing the original chunk.

3. The storage control system according to claim 2,
wherein the discovered target chunk is an empty chunk.

4. The storage control system according to claim 2,
wherein, when the target chunk is not discovered, the storage control unit in the at least one storage node or a management unit in a system communicating with the at least one storage node displays information representing a possibility of performance deterioration.

5. The storage control system according to claim 2,
wherein, when the target chunk is not discovered, the storage control unit in the at least one storage node or a management unit in a system communicating with the at least one storage node presents an addition of a storage device having a same transfer rate as the latest transfer rate.

6. The storage control system according to claim 2,
wherein the storage control unit in the at least one storage node or a management unit in a system communicating with the at least one storage node displays information representing improvement in a transfer rate complying with either an addition of a storage device having a same transfer rate as the latest transfer rate or a fact that the latest transfer rate is faster than an immediately preceding transfer rate.

7. A storage control method, wherein:
with regard to each of a plurality of storage nodes configuring a node group, for each storage device coupled to the storage node, a transfer rate of the storage device is acquired from device configuration information which includes information representing a transfer rate decided in establishing a link between the storage node and the storage device and which was acquired by an OS (Operating System) of the storage node,
a plurality of storage devices are coupled to the plurality of storage nodes,
each of the storage devices is coupled to one of the storage nodes and is not coupled to two or more storage nodes,
at least one storage node among the plurality of storage nodes manages a plurality of chunks, which are a plurality of logical storage areas, based on the plurality of storage devices,
when the node group receives a write request designating a write destination in a volume, one of the storage nodes makes redundant data associated with the write request, writes the redundant data in two or more storage devices which are a basis of two or more chunks configuring a chunk group assigned to a write destination area to which the write destination belongs, and notifies a completion of the write request when writing in the two or more storage devices is completed,
the chunk group is configured from two or more chunks based on two or more storage devices coupled to two or more storage nodes,
associated to each chunk is the transfer rate identified by the storage node to which the storage device, which is a basis of the chunk, is connected, and
for each of the chunk groups, two or more chunks configuring the chunk group are maintained as the two or more chunks associated with a same transfer rate.

8. The storage control method according to claim 7, wherein:
in each of the plurality of storage nodes, the storage node periodically identifies, for each storage device coupled to the storage node, the transfer rate of the storage information from the device configuration information of the storage device,
when the at least one storage node detects a storage device in which the transfer rate has changed, the storage control unit, for each chunk based on the storage device:
searches for a target chunk, which is a chunk associated with a transfer rate that is the same as a latest transfer rate of the storage device;
when the target chunk is discovered, transfers data in the chunk, which is an original chunk, to the target chunk; and
includes the target chunk, in substitute for the original chunk, in the chunk group containing the original chunk.

9. The storage control method according to claim 8,
wherein the discovered target chunk is an empty chunk.

10. The storage control method according to claim 8,
wherein, when the target chunk is not discovered, information representing a possibility of performance deterioration is displayed.

11. The storage control method according to claim 8,
wherein, when the target chunk is not discovered, an addition of a storage device having a same transfer rate as the latest transfer rate is presented.

12. The storage control method according to claim 8,
wherein information representing improvement in a transfer rate complying with either an addition of a storage device having a same transfer rate as the latest transfer rate or a fact that the latest transfer rate is faster than an immediately preceding transfer rate is displayed.
